(19) United States
(12) Patent Application Publication
(10) Pub. No.: US 2005/0219985 A1
(43) Pub. Date: Oct. 6, 2005

(54) Reproduced signal processor and reproduced signal processing method

(76) Inventor: Hiroyuki Nakahira, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/513,367

(22) PCT Filed: Sep. 2, 2003
(86) PCT No.: PCT/JP03/11200

§ 371 Date: Nov. 3, 2004

(51) Int. Cl. G11B 5/09

(52) U.S. Cl. 369/59.13; 369/124.1

(57) ABSTRACT

As shown in FIG. 1, in the reproduced signal processing apparatus (100) of the present invention, the pattern predictor (103) predicts a predicted value which is a data sequence of a reproduced signal X and judges whether the predicted value matches a previously set specific pattern or not, and the adaptive equalizer (110) performs adaptive equalization on the reproduced signal X with timely updating the coefficients W of the digital filter according to the judgement result from the pattern predictor (103), and the selection circuit (104) outputs one of the output from the adaptive equalizer (110) and the predicted value as a waveform-equalized output Y on the basis of the judgement result.

The reproduced signal processing apparatus (100) so constructed can realize optimal waveform equalization for coping with the non-linear distortion included in the reproduced signal.

### TECHNICAL FIELD

The present invention relates to a reproduced signal processing apparatus for equalizing a waveform of a reproduced signal which is reproduced from a recording medium and the reproduced signal processing method thereof.

### BACKGROUND ART

A reproduction circuit for an optical disk, a magnetic disk and the like is provided with an equalizer for performing waveform equalization of a reproduced signal therein so as to eliminate a waveform distortion or a noise which is included in the reproduced signal, thereby compensating intersymbol interference in the recording sequence. As the waveform equalization method, an adaptive equalization method in which the waveform distortion is estimated from the reproduced signal to determine a characteristic for the equalizer is employed.

Here, with reference to FIG. 12, a reproduced signal for when a recording pit on an optical disk, a magnetic disk and the like is evenly formed is compared with a reproduced signal for when a recording pit is uneven. FIG. 12 is a waveform diagram illustrating mark shapes and the reproduced signals for when the recording pit is evenly formed and for when the recording pit is uneven, respectively.

As shown in FIG. 12, when the recording pit is evenly formed, the mark shape is completely rectangular. On the other hand, when the recording pit is uneven, the mark shape has larger distortion on the both sides or at the center of the pit. When these signals are read by a pickup or the like in the reproduction circuit, in a case where the recording pit is evenly formed, the level of the reproduced signal takes a constant value at the center, and in a case where the recording pit is uneven, the level of the reproduced signal becomes distorted at the center, and the reproduced signal X becomes like a signal on which a frequency is superimposed.

However, a prior art equalizer is constructed so as to perform only linear operations such as delaying the reproduced signals and performing multiplication of coefficients and addition and is directed to eliminate linear distortions of the reproduced signals. Therefore, when non-linear distortion which is partly caused by production variances of a medium such as an optical disk and a magnetic disk, or the like is included in the reproduced signal (for example, refer to the reproduced signal for when the recording pit is uneven as shown in FIG. 12), the prior art equalizer cannot eliminate the distortion component. Then, the non-linear distortion included in the reproduced signal substantially reduces the equalization ability of the equalizer, and therefore reduction in performance of the reproduction circuit such as degradation in bit error rate cannot be avoided.

As an apparatus for solving the problem of the prior art, a reproduced signal processing apparatus for performing waveform equalization processing taking into consideration an influence of the non-linear distortion of the reproduced signal is disclosed in the Japanese Patent No. 2768296.

Hereinafter, a prior art reproduced signal processing apparatus will be described with using FIGS. 13, 14, and 15. FIG. 13 is a diagram illustrating a construction of the prior art reproduced signal processing apparatus, FIG. 14 is a diagram illustrating a detail of a construction of a digital filter in the prior art reproduced signal processing apparatus, and FIG. 15 is a diagram illustrating a detail of a construction of a coefficient updater in the prior art reproduced signal processing apparatus.

In FIG. 13, a prior art reproduced signal processing apparatus 400 comprises a digital filter 401 and a coefficient updater 402. Then, the digital filter 401 is a filter for receiving a reproduced signal X obtained by digitizing a signal reproduced from an optical disk such as a CD and a DVD by a quantization section (not shown) in a reproduction circuit, and here it is a FIR (Finite Impulse Response) filter of 5 taps as shown in FIG. 14. Hereinafter, a detailed description will be given with using FIG. 14. The digital filter 401 comprises 5 D flip-flops 411a to 411e connected to each other so as to constitute multiple stages of delay elements each of which delays propagation of the reproduced signal X, 5 multipliers 412a to 412e for multiplying the delayed signals X₁ to X₅ outputted from the D flip-flops 411a to 411e by coefficients W₁ to W₅, respectively, and an adder 413 for adding the outputs from the respective multipliers 412. Therefore, the output X′ of the digital filter 401 is a value which is obtained by multiplying the delayed signals X₁ to X₅ obtained by delaying the reproduced signal X by the coefficients W₁ to W₅, respectively, and adding all the multiplication resultants in the adder 413.

Then, the coefficient updater 402 adaptively updates the coefficients W₁ to W₅ for determining an equalization characteristic for the digital filter 401 according to the output of the digital filter 401, and here the coefficient updater 402 comprises a correlation unit 421, an integrator 422, a subtracter 423, a reference amplitude generation circuit 424, a ternary discrimination circuit 425, an error signal selection circuit 426, and a switch 427, as shown in FIG. 15. Then, the ternary discrimination circuit 425 makes a discrimination as to the digital filter output X′ which is output from the digital filter 401 to assign one of three values (for example, −1, 0, +1) to the output X′ according to a predetermined threshold value, the reference amplitude generation circuit 424 converts the three values (for example, −1, 0, +1) output from the ternary discrimination circuit 425 into amplitude values corresponding to the output levels of the digital filter 401, respectively, the subtracter 423 calculates an equalization error ε which is a difference between an output of the reference amplitude generation circuit 424 and the digital filter output X′, the correlation unit 421 takes a correlation between a delayed signal Xₙ which is input from the digital filter 401 and an equalization error εₙ from the subtracter 423, the integrator 422 supplies a value obtained by time-integrating each of the correlations taken by the correlation unit 421 as an updated coefficient Wₙ, to the digital filter 401, the error signal selection circuit 426 generates a selection signal for selecting whether or not the equalization error ε calculated by the subtracter 423 is to be input to the correlation unit 421, on the basis of the time-series information of output from the ternary discrimination circuit 425, and the switch 427 switches between on and off, according to the selection signal from the error signal selection circuit 426.

In such a prior art reproduced signal processing apparatus 400, the coefficient updater 402 previously sets distinctive patterns which seem to have non-linear distortions from among the outputs of the ternary discrimination circuit 425 in the error signal selection circuit 426, and the error signal selection circuit 426 judges whether or not the previously set distinctive patterns match the outputs from the ternary discrimination circuit 425. When there is no matching, the error signal selection circuit 426 turns on the switch 427 to update the coefficients W₁ to W₅. When there is a matching, the error signal selection circuit 426 turns off the switch 427 so as not to update the coefficients W₁ to W₅. Thereby, an influence which the non-linear distortion of the reproduced signal X exerts on the update of the coefficients W₁ to W₅ can be controlled.

However, a failure in the waveform equalization is not caused only by the above-described adaptive control of the coefficient update in the coefficient updater 402, and there are some cases where the digital filter output X′ subjected to waveform equalization by the digital filter 401 (hereinafter, also referred to as “waveform-equalized output X′”) itself is a cause of the failure in waveform equalization.

Hereinafter, a specific description will be given with using FIG. 16. FIG. 16 is a diagram illustrating a reproduced signal X inclusive of non-linear distortion and a waveform-equalized output Y obtained by adaptively equalizing the reproduced signal X.

As described with reference to FIG. 12, a reproduced signal having large non-linear distortion may be a signal on which a signal in a certain frequency band which is not included in normal waveform of the reproduced signal is superimposed. In a case where the superimposed frequency band is far from the frequency band of the reproduced signal, the digital filter 401 can easily eliminate the superimposed signal. On the other hand, in a case where the superimposed frequency band is close to the frequency band of the reproduced signal, it cannot be determined whether the large distortion of the waveform of the reproduced signal is a waveform distortion due to non-linear distortion or normal waveform of the reproduced signal, and therefore it becomes very difficult to correct the non-linear distortion of the waveform.

For example, A, B, and D portions among A to D portions which are large distortions of the waveform of the reproduced signal X as shown in FIG. 16 are non-linear distortions which are caused by superimposing a normal waveform on a signal of the same frequency band as that of the normal waveform, and C portion is a normal waveform of the reproduced signal. When the prior art apparatus 400 subjects such a waveform to waveform equalization, in a case where the reproduced signal X has a distortion component of the same frequency band as that of the normal waveform portion, even when the coefficients W₁ to W₅ are not updated for the distortion portion, the distortion component of the reproduced signal itself is similarly amplified, thereby resulting in failure in the waveform equalization (refer to the A, B, and D portions in FIG. 16). Then, when the constraints for coding is satisfied, even a post-stage decoder such as a Viterbi decoder not shown cannot correct the error and then the reproduced signal may be decoded as it is, and therefore the failure in the waveform equalization is a cause of the degradation in the decoding performance of the reproduction circuit.

Accordingly, even if the coefficients W₁ to W₅ are not updated for the portions which seem to be non-linear distortions of the waveform of the reproduced signal X as in the prior art reproduced signal processing apparatus 400, there are some cases where influence of non-linear distortion on the waveform-equalized output X′ cannot be controlled. As a result, in the prior art reproduced signal processing apparatus 400, the digital filter 401 cannot have a waveform equalization characteristic which sufficiently copes with the non-linear distortion and there is a problem that the reproduced signal including non-linear distortion cannot be optimally waveform-equalized.

The present invention is made in view of the above-described problems and its object is to provide a reproduced signal processing apparatus which copes with a non-linear distortion included in a reproduced signal and can realize optimal waveform equalization.

### DISCLOSURE OF THE INVENTION

In order to solve the above-described problems, a reproduced signal processing apparatus according to the present invention is a reproduced signal processing apparatus for equalizing a waveform of a reproduced signal which is reproduced from a recording medium which comprises: a digital filter for equalizing the reproduced signal; a coefficient updater for adaptively updating coefficients for determining an equalization characteristic of the digital filter; a pattern predictor for predicting a data sequence of the reproduced signal and outputting a predicted value of the reproduced signal, and judging whether or not the data sequence of the reproduced signal is a previously set specific pattern, thereby to output the judgement result; and a selection circuit for selecting one of the output of the digital filter and the predicted value of the reproduced signal as a waveform-equalized output, and outputting the selected one.

Therefore, the reproduced signal is adaptively equalized, and thereafter one of the adaptively equalized output and the data sequence predicted from the reproduced signal is selected and outputted as a waveform-equalized output, thereby realizing optimal waveform equalization for coping with non-linear distortion included in the reproduced signal.

Further, in the reproduced signal processing apparatus according to the present invention, the selection circuit selects the output of the digital filter when the judgement result indicates that the data sequence of the reproduced signal is the specific pattern, and selects the predicted value when the judgement result indicates that the data sequence of the reproduced signal is not the specific pattern.

Therefore, the influence which the non-linear distortion included in the reproduced signal exerts on the waveform-equalized output can be optimally controlled.

Further, in the reproduced signal processing apparatus according to the present invention, the coefficient updater updates the coefficients of the digital filter when the judgement result indicates that the data sequence of the reproduced signal is the specific pattern, and does not update the coefficients of the digital filter when the judgement result indicates that the data sequence of the reproduced signal is not the specific pattern.

Therefore, the influence which the non-linear distortion included in the reproduced signal exerts on the update of the coefficients of the digital filter can be controlled.

Further, in the reproduced signal processing apparatus according to the present invention, the coefficient updater adaptively updates the coefficients of the digital filter using the predicted value.

Therefore, the influence which the non-linear distortion included in the reproduced signal exerts on the update of the coefficients of the digital filter can be optimally controlled.

Further, in the reproduced signal processing apparatus according to the present invention, the digital filter equalizes the reproduced signal into multiple values and outputs the equalized signal, and the specific patterns which are previously set in the pattern predictor are portions in which the data sequence of the reproduced signal changes from a minimum value up to a maximum value and in which it changes from the maximum value up to the minimum value.

Therefore, even when the non-linear distortion of the same frequency band as that of the normal waveform of the reproduced signal is included, the influence which the non-linear distortion exerts on the waveform-equalized output can be controlled, thereby performing waveform equalization optimally.

Further, in the reproduced signal processing apparatus according to the present invention, the digital filter equalizes the reproduced signal into multiple values and outputs the equalized signal, and the specific pattern which is previously set in the pattern predictor is a portion in which the data sequence of the reproduced signal is other than the minimum value and the maximum value.

Therefore, even when the non-linear distortion of the same frequency band as that of the normal waveform of the reproduced signal is included, the influence which the non-linear distortion exerts on the waveform-equalized output can be controlled, thereby performing waveform equalization optimally.

Further, in the reproduced signal processing apparatus according to the present invention, the pattern predictor predicts the data sequence of the reproduced signal using partial response equalization, and judges whether the predicted data sequence of the reproduced signal matches the specific pattern or not.

Therefore, even when the non-linear distortion of the same frequency band as that of the normal waveform of the reproduced signal is included, the influence which the non-linear distortion exerts on the waveform-equalized output can be controlled, thereby performing waveform equalization optimally.

Further, a reproduced signal processing apparatus according to the present invention is a reproduced signal processing apparatus for equalizing a waveform of a reproduced signal which is reproduced from a recording medium, which comprises: a pattern predictor for judging whether or not the data sequence of the reproduced signal is a previously set specific pattern, thereby to output the judgement result; a prediction filter for partially performing filtering on the reproduced signal on the basis of the judgement result; and an adaptive equalizer for adaptively equalizing the output of the prediction filter.

Therefore, the reproduced signal is partially subjected to filtering and is then adaptively equalized, thereby realizing optimal waveform equalization for coping with the non-linear distortion included in the reproduced signal.

Further in the reproduced signal processing apparatus according to the present invention, the pattern predictor makes judgement as to the data sequence of the reproduced signal and predicts the data sequence of the reproduced signal to output the predicted value of the reproduced signal; the prediction filter outputs the reproduced signal when the judgement result indicates that the data sequence of the reproduced signal is the specific pattern; and outputs the predicted value of the reproduced signal when the judgement result indicates that the data sequence of the reproduced signal is not the specific pattern.

Therefore, even when the non-linear distortion of the same frequency band as that of the normal waveform of the reproduced signal is included, the influence which the non-linear distortion exerts on the waveform-equalized output can be controlled, thereby performing waveform equalization optimally.

Further, in the reproduced signal processing apparatus according to the present invention, the filtering processing performed by the prediction filter is to eliminate a specific frequency band from the waveform of the reproduced signal only when the judgement result indicates that the data sequence of the reproduced signal is not the specific pattern.

Therefore, the influence of the filtering does not occur except in the portions of the specific patterns of the data sequence of the reproduced signal, thereby supplying a signal having little non-linear distortion to the adaptive equalizer in the post stage.

Further, in the reproduced signal processing apparatus according to the present invention, the specific patterns which are previously set in the pattern predictor are portions in which the predicted data sequence of the reproduced signal changes from a minimum value up to a maximum value and in which it changes from the maximum value up to the minimum value.

Therefore, even when the non-linear distortion of the same frequency band as that of the normal waveform of the reproduced signal is included, the influence which the non-linear distortion exerts on the waveform-equalized output can be controlled, thereby performing waveform equalization optimally.

Further, in the reproduced signal processing apparatus according to the present invention, the specific pattern which is previously set in the pattern predictor is a portion in which the predicted data sequence of the reproduced signal is other than the minimum value and the maximum value.

Therefore, even when the non-linear distortion of the same frequency band as that of the normal waveform of the reproduced signal is included, the influence which the non-linear distortion exerts on the waveform-equalized output can be controlled, thereby performing waveform equalization optimally.

Further, a reproduced signal processing method according to the present invention is a reproduced signal processing method for equalizing a waveform of a reproduced signal which is reproduced from a recording medium, which comprises: an adaptive equalization step of adaptively equalizing the reproduced signal with updating coefficients for determining an equalization characteristic of the waveform, thereby to output the equalized signal; a prediction step of predicting the data sequence of the reproduced signal and outputting the predicted value of the reproduced signal; a judgement step of judging whether or not the data sequence of the reproduced signal is a previously set specific pattern, thereby to output the judgement result; and a selection step of selecting one of the output of the equalization step and the output of the prediction step as a waveform-equalized output, and outputting the selected one.

Therefore, one of the reproduced signal which was adaptively equalized and the predicted value which is predicted from the reproduced signal is selected and outputted as a waveform-equalized output, thereby realizing optimal waveform equalization for coping with non-linear distortion included in the reproduced signal.

Further, a reproduced signal processing method according to the present invention is a reproduced signal processing method for equalizing a waveform of a reproduced signal which is reproduced from a recording medium, which comprises: a judgement step of judging whether or not the data sequence of the reproduced signal is a previously set specific pattern, thereby to output the judgement result; a filtering step of partially performing filtering on the reproduced signal on the basis of the judgement result; and an adaptive equalization step of adaptively equalizing the output of the filtering step.

Therefore, the reproduced signal is subjected to filtering, and thereafter the output which was subjected to filtering can be adaptively equalized, thereby realizing optimal waveform equalization for coping with non-linear distortion included in the reproduced signal.

### BRIEF DESCRIPTION OF THE DRAWINGS

FIG. 1 is a diagram illustrating a construction of a reproduced signal processing apparatus according to a first embodiment of the present invention.

FIG. 2 is a diagram illustrating a detail of a construction of a coefficient updater in the reproduced signal processing apparatus according to the first embodiment of the present invention.

FIG. 3 is a diagram illustrating a detail of a construction of a pattern predictor in the reproduced signal processing apparatus according to the first embodiment of the present invention.

FIG. 4 is a waveform diagram illustrating an operation of the pattern predictor in the reproduced signal processing apparatus according to the first embodiment of the present invention.

FIG. 5 is a waveform diagram showing reproduced signals and predicted values thereof in a case where a reproduced signal to be input to the reproduced signal processing apparatus is normal (Xa) and in a case where a reproduced signal to be input to the reproduced signal processing apparatus has a large non-linear distortion (Xb), respectively, according to the first embodiment of the present invention.

FIG. 6 is a diagram for explaining an operation of the coefficient updater in the reproduced signal processing apparatus according to the first embodiment of the present invention.

FIG. 7 is a diagram for explaining an operation of a selection circuit in the reproduced signal processing apparatus according to the first embodiment of the present invention.

FIG. 8 is a waveform diagram showing a reproduced signal which is input to the reproduced signal processing apparatus, predicted values of the reproduced signal, and a waveform-equalized output obtained by equalizing the reproduced signal, according to the first embodiment of the present invention.

FIG. 9 is a diagram illustrating a construction of a reproduced signal processing apparatus according to a second embodiment of the present invention.

FIG. 10 is a waveform diagram illustrating an operation of a prediction filter in the reproduced signal processing apparatus according to the second embodiment of the present invention.

FIG. 11 is a waveform diagram illustrating an operation of a prediction filter of a modification of the reproduced signal processing apparatus according to the second embodiment of the present invention.

FIG. 12 is a diagram illustrating mark shapes and the reproduced signals for when a recording pit to be recorded on a recording medium is even and for when a recording pit is uneven, respectively.

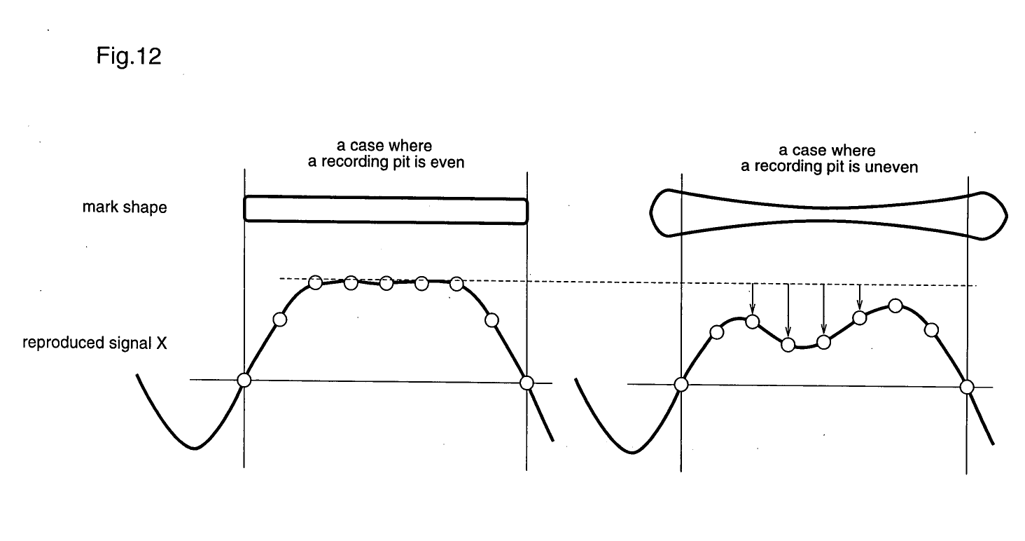

FIG. 13 is a diagram illustrating a construction of a prior art reproduced signal processing apparatus.

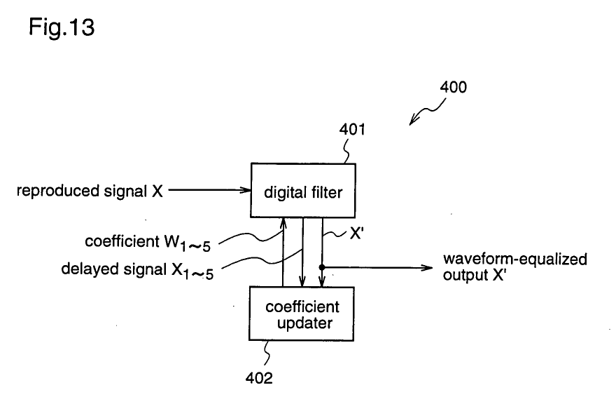

FIG. 14 is a diagram illustrating a detail of a construction of a digital filter in the prior art reproduced signal processing apparatus.

FIG. 15 is a diagram illustrating a detail of a construction of a coefficient updater in the prior art reproduced signal processing apparatus.

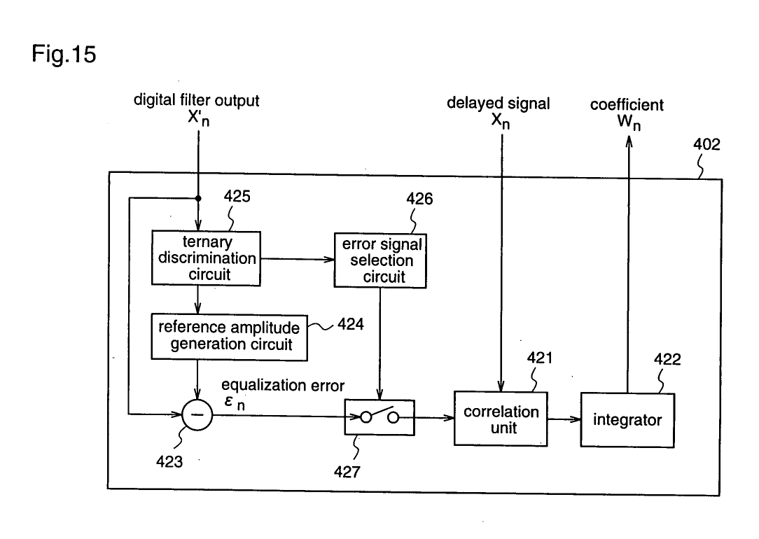

FIG. 16 is a waveform diagram illustrating a reproduced signal which is input to the prior art reproduced signal processing apparatus and waveform-equalized output obtained by equalizing the reproduced signal.

### BEST MODE TO EXECUTE THE INVENTION

### Embodiment 1

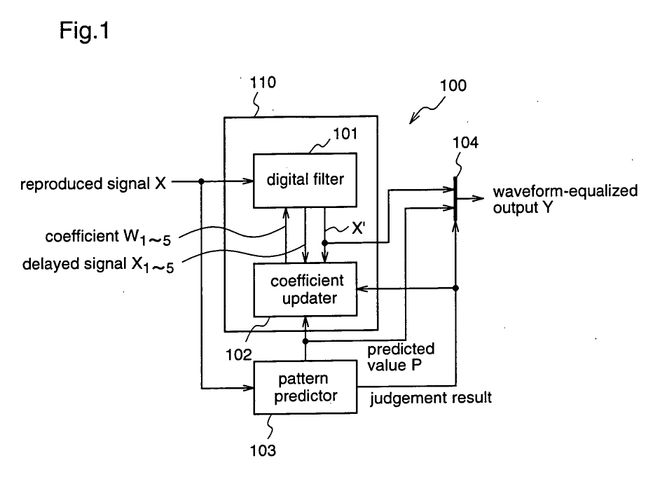

Hereinafter, a reproduced signal processing apparatus according to a first embodiment will be described with reference to FIGS. 1 to 8 and 14.

In the first embodiment, in a case where a reproduced signal including non-linear distortion is adaptively equalized, the influence of the non-linear distortion is considered not only for the update of coefficients W₁ to W₅ for determining an equalization characteristic of a digital filter, but also for adaptively-equalized waveform-equalized output which is outputted from the digital filter.

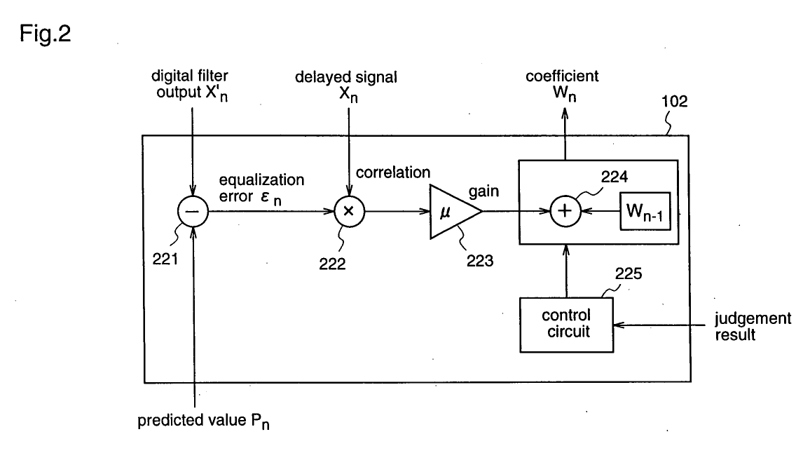

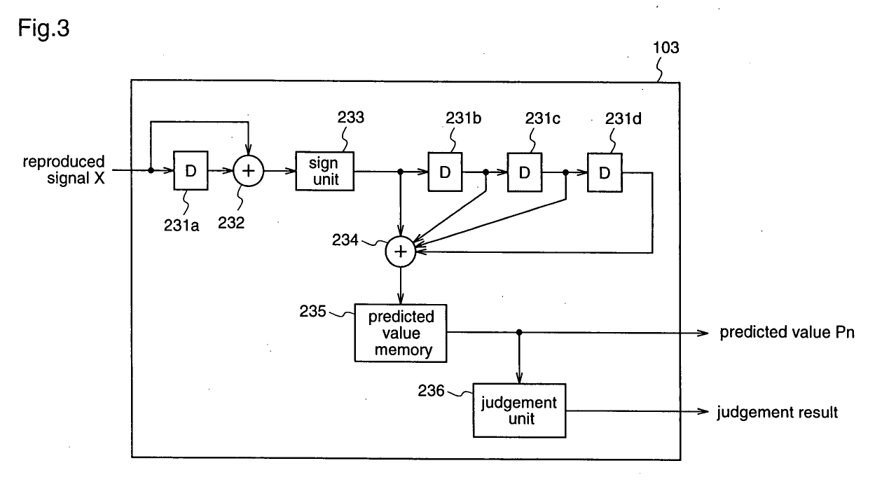

Initially, a construction of the reproduced signal processing apparatus according to the first embodiment will be described with reference to FIGS. 1 to 3 and 14. FIG. 1 is a diagram illustrating a construction of the reproduced signal processing apparatus according to the first embodiment, FIG. 2 is a diagram illustrating a detail of a construction of a coefficient updater of the reproduced signal processing apparatus according to the first embodiment, and FIG. 3 is a diagram illustrating a detail of a construction of a pattern predictor of the reproduced signal processing apparatus according to the first embodiment.

In FIG. 1, the reproduced signal processing apparatus 100 according to the first embodiment comprises an adaptive equalizer 110 including a digital filter 101 and a coefficient updater 102, a pattern predictor 103, and a selection circuit 104.

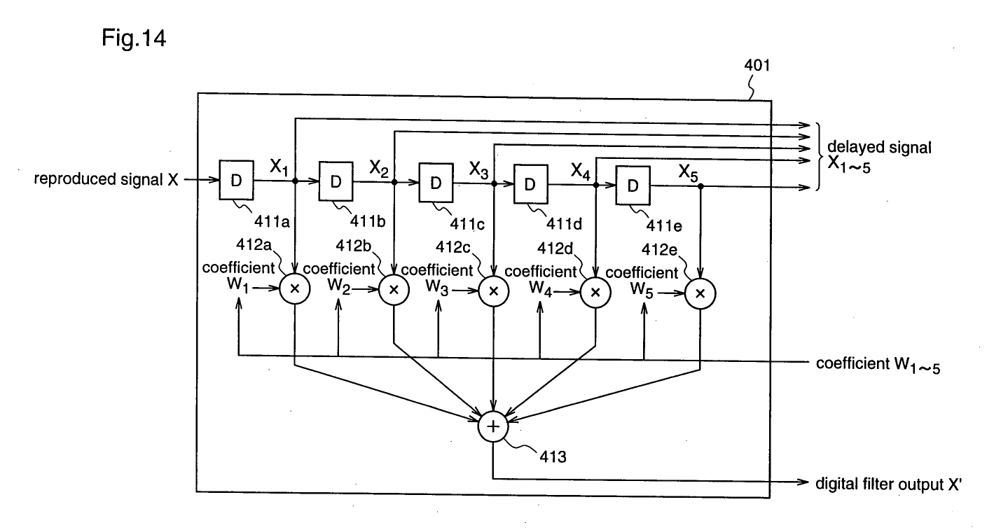

Then, the digital filter 101 of the adaptive equalizer 110 receives a reproduced signal X obtained by digitizing a signal reproduced from an optical disk such as a CD and a DVD in a quantization circuit (not shown) which is in a previous stage of the adaptive equalizer 110. The coefficient updater 102 adaptively updates the coefficients W₁ to W₅ for determining an equalization characteristic of the digital filter 101 according to the reproduced signal X, a predicted value P and a judgement result of the pattern predictor 103, which will be described later, and an output X′ of the digital filter 101. The adaptive equalizer 110 adaptively equalizes the reproduced signal X in the digital filter 101 with using the coefficient W which has been timely updated by the coefficient updater 102. Then, in the first embodiment, the digital filter 101 is constructed as a FIR (Finite Impulse Response) filter of 5 taps shown in FIG. 14 like the prior art digital filter 401 described above, and the number of coefficients W which are timely updated by the coefficient updater 102 is 5 (W₁ to W₅).

Then, the pattern predictor 103 predicts a binary data sequence (a predicted value P) obtained from the reproduced signal X, and judges whether or not the predicted value P which is the predicted data sequence matches a previously set specific pattern, thereby outputting the judgement result. Further, the selection circuit 104 receives a digital filter output X′ from the digital filter 101, and the predicted value P and the judgement result from the pattern predictor 103, and outputs one of the digital filter output X′ and the predicted value P as a waveform-equalized output Y on the basis of the judgement result.

Hereinafter, the details of the constructions of the coefficient updater 102 and the pattern predictor 103 will be described with using FIGS. 2 and 3, respectively.

Initially, as shown in FIG. 2, the coefficient updater 102 comprises a subtracter 221 for calculating an equalization error εₙ which is a difference between a digital filter output X′ₙ which is output from the digital filter 101 and a predicted value Pₙ, a multiplier 222 for taking a correlation between each delayed signal Xₙ obtained by delaying the reproduced signal X by the D flip-flop in the digital filter 101 for taking a clock delay into consideration and an equalization error εₙ from the subtracter 221, an amplifier 223 for amplifying the output from the multiplier 222 at an amplification factor μ, an adder 224 for adding the output from the amplifier 223 and the (n−1)th coefficient Wₙ₋₁ and outputting the updated coefficient Wₙ, and a control circuit 225 for controlling whether or not the updated coefficient Wₙ is to be output from the adder 224 on the basis of the judgement result from the prediction pattern determination unit 103. Under the control of the control circuit 225, the coefficient Wₙ is updated so that the second power of the equalization error εₙ is minimized, thereby adaptively controlling the equalization characteristic of the digital filter 101 according to the waveform characteristic of the reproduced signal X. Then, while the coefficient updater 102 shown in FIG. 2 is constructed so as to update only one coefficient W in one update, all the coefficients Wₙ₋₄, Wₙ₋₃, Wₙ₋₂, Wₙ₋₁, Wₙ (here, coefficients W₁ to W₅) can be updated in one update when the similar circuits are provided by the number of coefficients Wₙ (here 5 pieces).

As shown in FIG. 3, the pattern predictor 103 comprises D flip-flops 231a to 231d each of which delays the reproduced signal X by one clock, an adder 232 for adding the reproduced signal X and the signal which is obtained by delaying the reproduced signal X by one clock in the D flip-flop 231a, a sign unit 233 for calculating a sign of the output from the adder 232, an adder 234 for adding the output from the sign unit 233, and the outputs each of which is obtained by delaying the output from the sign unit 233 by one clock in each of the three D flip-flops 231b to 231d, thereby executing PR (1,1,1,1), a predicted value memory 235 for outputting a predicted value P on the basis of the result of the PR (1,1,1,1), and a judgement unit 236 for judging whether the predicted value P is a previously set specific pattern or not. Using the partial response PR (1,1,1,1), the pattern predictor 103 predicts a data sequence of the reproduced signal X to output a predicted value P, and judges whether the predicted value P is the previously set specific pattern or not, thereby outputting the judgement result. Then, the PR (1,1,1,1) is a signal obtained from 1+D₁+D₂+D₃, and D_{m(m=1 to 3)} is a signal which is obtained by delaying the reproduced signal X by m clocks. Then, the binary data sequence of the reproduced signal X which was equalized into multiple values (predicted value P) can be obtained by using the PR (1,1,1,1) because signals of DVD are coded in the modulation/demodulation scheme of EFM+, and the signals of DVD are recorded in the modulation scheme called NRZI (Non Return to Zero Inverted) at the recording.

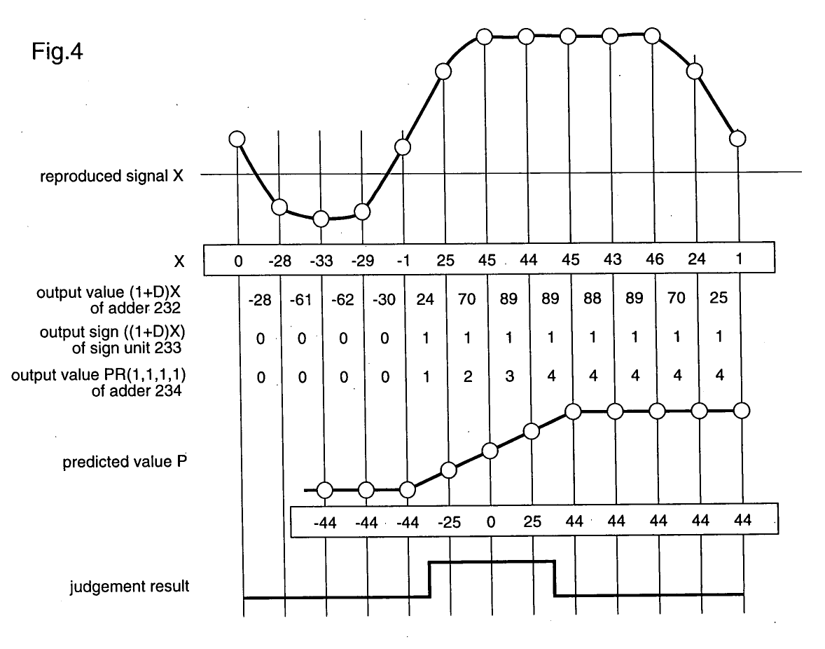

Next, a series of operations of the reproduced signal processing apparatus of the above-described construction according to the first embodiment will be described with reference to FIGS. 4 to 8. FIG. 4 is a diagram illustrating values obtained by the respective sections of the pattern predictor according to the first embodiment.

Initially, a reproduced signal X which is digitized by the quantization means not shown is input to the adaptive equalizer 110 and the pattern predictor 103.

In the adaptive equalizer 110, the digital filter 101 performs adaptive equalization according to the coefficients W₁ to W₅ which are supplied from the coefficient updater 102 on the input reproduced signal X as in the prior art apparatus 400 which has been previously described, and outputs the equalized digital filter output X′ to the selection circuit 104.

At the same time, the pattern predictor 103 predicts a data sequence of the input reproduced signal X to output the predicted data sequence as a predicted value P of the reproduced signal X to the selection circuit 104, and simultaneously judges whether or not the predicted value P matches the previously set specific pattern and outputs the judgement result to the coefficient updater 102 and the selection circuit 104.

Hereinafter, the operation of the pattern predictor 103 will be described in detail with using FIG. 4. Initially, when a reproduced signal X having a value as shown in FIG. 4 is input to the pattern predictor 103, the reproduced signal X is delayed by one clock by the D flip-flop 231a and thereafter the delayed reproduced signal X is added to the reproduced signal X to obtain a value (1+D) X by the adder 232. Here, (1+D) is calculated initially so as to easily realize a function similar to that of an interpolation filter implemented by a Nyquist filter. Here, by performing operation (1+D), a level equivalent to that of the intermediate point of 2 adjacent sampling points is obtained. Then, the Nyquist filter may be constructed by a FIR filter of plural taps.

Subsequently, the value (1+D)X output from the adder 232 is input to the sign unit 233, and the sign unit 233 obtains a value of sign (1+D)X. Here, when the value of output (1+D)X of the adder 232 is negative, the value of sign (1+D)X is set to “0”, and when the value is not negative, the value of sign (1+D)X is set to “1”.

Then, the value of sign (1+D)X output from the sign unit 233 is delayed by one clock in the D flip-flops 231b to 231d, respectively, and the adder 234 adds the output of the sign unit 233 and the respective outputs from the D flip-flops 231b to 231d to obtain a value of PR (1,1,1,1). Here, since the value of PR (1,1,1,1) is obtained by delaying the reproduced signal X by one clock in the D flip-flops 231a to 231d, respectively, and adding all the delayed values by the adder 234, the value of PR (1,1,1,1) output from the adder 234 takes values of “0” to “4” as shown in FIG. 4.

The value of PR (1,1,1,1) always changes from the previous value only by +1, −1 or 0 because of a characteristic of DVD reproduced signal. Accordingly, when the reproduced signal X to be input to the reproduced signal processing apparatus 100 is a DVD reproduced signal, a value PR (1,1,1,1) of the signal, which is predicted from the reproduced signal X, changes to such as 0→0→1→2→3→4→4→4→3→2→1→2→3→4, and the value PR never changes to such as 0→4→2→4→1→3.

Then, the predicted value memory 235 outputs a predicted value P which is a predicted data sequence of the reproduced signal X on the basis of the output from the adder 234. Here, the values corresponding to output values, 0, 1, 2, 3, and 4, of the adder 234 are −44, −25, 0, 25, and 44, respectively, and in the predicted value memory 235, the five values are applied correspondingly to the inputted output value PR (1,1,1,1) of the adder 234, and the value is output as predicted value P of the reproduced signal X. 5 values corresponding to the output values of the adder 234 are thus provided as the predicted value P so that the predicted value P falls within a range of the values which the reproduced signal X can take. Thereby, the waveform-equalized output Y which is outputted from the reproduced signal processing apparatus 100 of the first embodiment is equalized into these 5 values. Then, five values (−44, −25, 0, 25, 44) are described here as an example, and any value which the reproduced signal X can take may be used. Further, while in the first embodiment what outputs the predicted value P is referred to as a predicted value memory 235, it is not restricted to a memory, and whatever has the same function as that of the predicted value memory 235, for example, a combination of a register and a multiplexer, can be used.

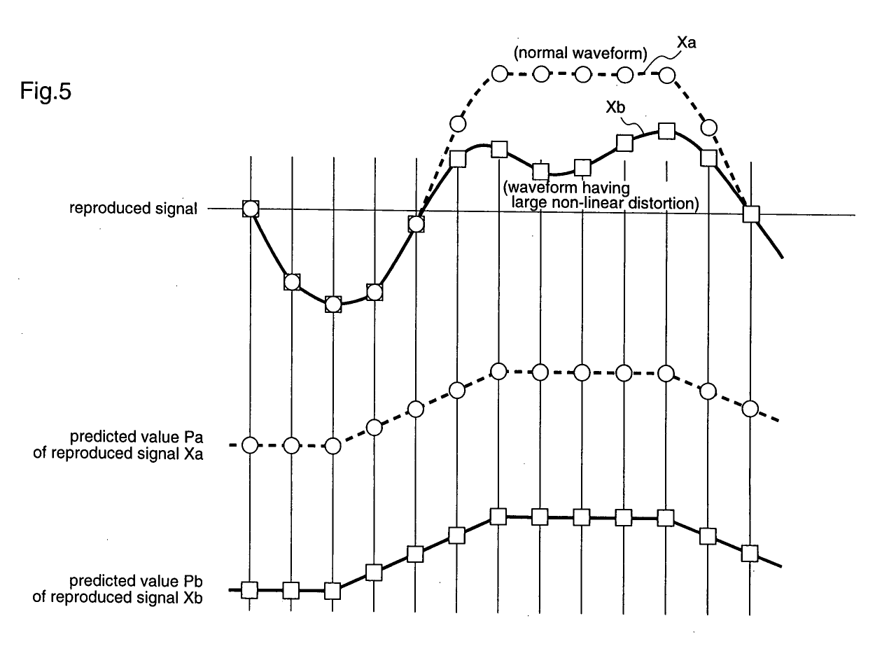

Here, comparing the predicted value P of the reproduced signal X obtained as above-described for when the reproduced signal X is normal (waveform Xa) and that for when the reproduced signal X has large non-linear distortion (waveform Xb), as shown in FIG. 5, when a signal as a reference, for example, 0 (zero) level, is being maintained constant by an offset canceller not shown regardless of whether the non-linear distortion is present or not, the predicted value P of the reproduced signal is the same regardless of whether the waveform distortion of the reproduced signal is large or small. It is apparent also from the contents of the operation of the pattern predictor 103, that is, the contents that the PR (1,1,1,1) is executed with using sign of the intermediate point of 2 adjacent sampling points.

Then, the predicted value P of the reproduced signal X which is output from the predicted value memory 235 is output to the judgement unit 236, and the judgement unit 236 judges whether the predicted value P matches the previously set specific pattern or not.

For example, a portion in which the predicted value P changes up to a maximum value, or up to a minimum value, that is, a portion in which the predicted value P changes to “−25”, “0”, “25” is previously set as the specific pattern in the judgement unit 236, and in a case where a judgement result that an edge is to be raised is output when the change of the predicted value P matches the specific pattern, the judgement unit 236 outputs the judgement result that a portion in which the predicted value P changes to “−25”, “0”, “25” should be an edge portion, as a judgement result, as shown in FIG. 4. Then, while in the first embodiment, the predicted value P which is an output from the predicted value memory 235 is input to the judgement unit 236, the output of the adder 234 may be input to the judgement unit 236 since the output values (0 to 4) of the adder 234 correspond to and are equivalent to the predicted values P (−44, −25, 0, 25, 44) as described above. In this case, a portion in which the output value of the adder 234 changes to “1”, “2”, “3” is previously set as a specific pattern in the judgement unit 236, thereby obtaining the same result as that for the case where the portion in which the predicted value changes to “−25”, “0”, “25” is set as the specific pattern as described above.

Then, the judgement result so obtained is output to the control circuit 225 in the coefficient updater 102 and the selection circuit 104, and the control circuit 225 in the coefficient updater 102 controls whether or not the coefficients W₁ to W₅ should be updated according to the judgement result, and the selection circuit 104 selects which of the digital filter output X′ and the predicted value P of the reproduced signal X is to be output as a waveform-equalized output Y according to the judgement result.

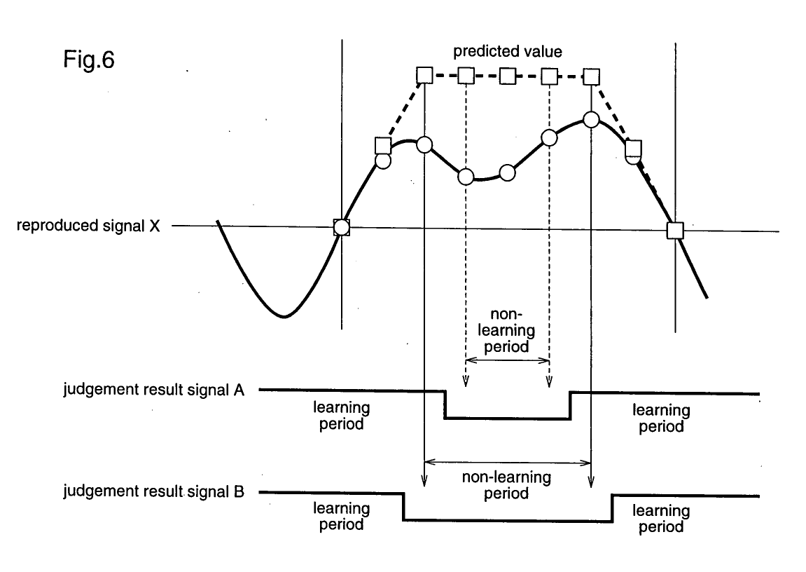

Initially, a case where the judgement result is used to update the coefficients W₁ to W₅ will be described with reference to FIG. 6. FIG. 6 is a diagram for explaining a judgement method executed by the judgement unit at the updating of the coefficient according to the first embodiment. Then, “learning” shown in FIG. 6 is to adaptively change the equalization characteristic, that is, to execute the update of the coefficient, while “non-learning” is to unchange the equalization characteristic, that is, to execute no update of the coefficient.

For example, in a case where a portion in which the predicted value P changes from a maximum value up to a minimum value, and a portion in which the predicted value P changes from a minimum value up to a maximum value, are set as the specific patterns, a signal A shown in FIG. 6 is output as the judgement result from the judgement unit 236 in the pattern predictor 103. Then, in a case where a portion in which the predicted value P is other than the maximum value and the minimum value, is set as the specific pattern, a signal B shown in FIG. 6 is output as the judgement result from the judgement unit 236 in the pattern predictor 103.

Then, when the control circuit 225 in the coefficient updater 102 receives the judgement result obtained as described above, the control circuit 225 in the coefficient updater 102 performs control so that the update of the coefficients W₁ to W₅ is not adaptively executed according to the reproduced signal X in the “non-learning” period (a non-edge portion), while the control circuit 225 performs control so that the update of the coefficients W₁ to W₅ is executed in the “learning” period (an edge portion). Therefore, even when a reproduced signal of large non-linear distortion is input, the inappropriate coefficient update due to the non-linear distortion can be avoided, thereby improving the convergence of the coefficient update.

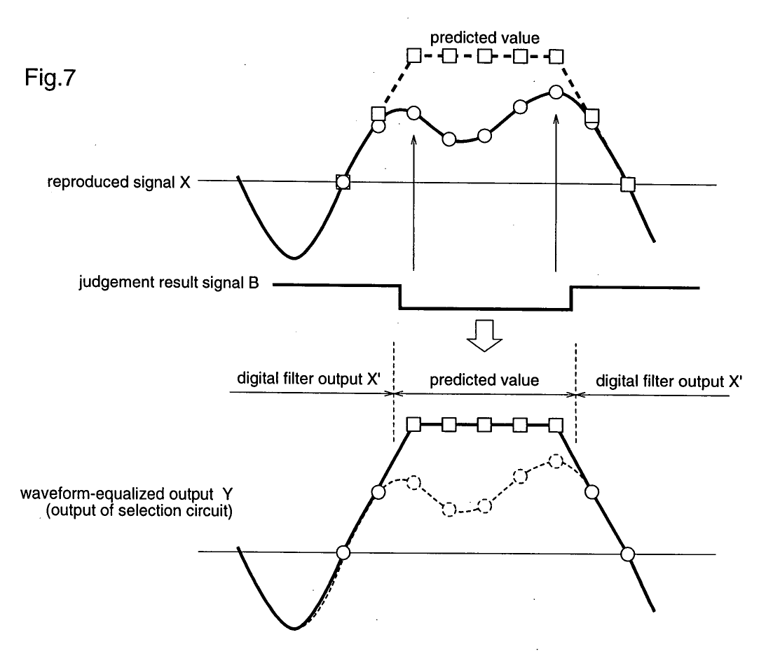

Next, a case where the judgement result is used for the waveform equalization will be described with reference to FIG. 7. FIG. 7 is a diagram for explaining the judgement method executed by the judgement unit at the waveform equalization according to the first embodiment. Here, the judgement result signal B shown in FIG. 6 is taken as an example.

As described above, the judgement result obtained by the judgement unit 236 in the pattern predictor 103 is output to the selection circuit 104. Then, the selection circuit 104 outputs digital filter output X′ as a waveform-equalized output Y in a portion in which the predicted value P of the reproduced signal changes to “−25”, “0”, “25”, and outputs the corresponding predicted value P, instead of the digital filter output X′, as a waveform-equalized output Y except in a portion where the predicted value P of the reproduced signal changes to “−25”, “0”, “25”, on the basis of the judgement result from the pattern predictor 103.

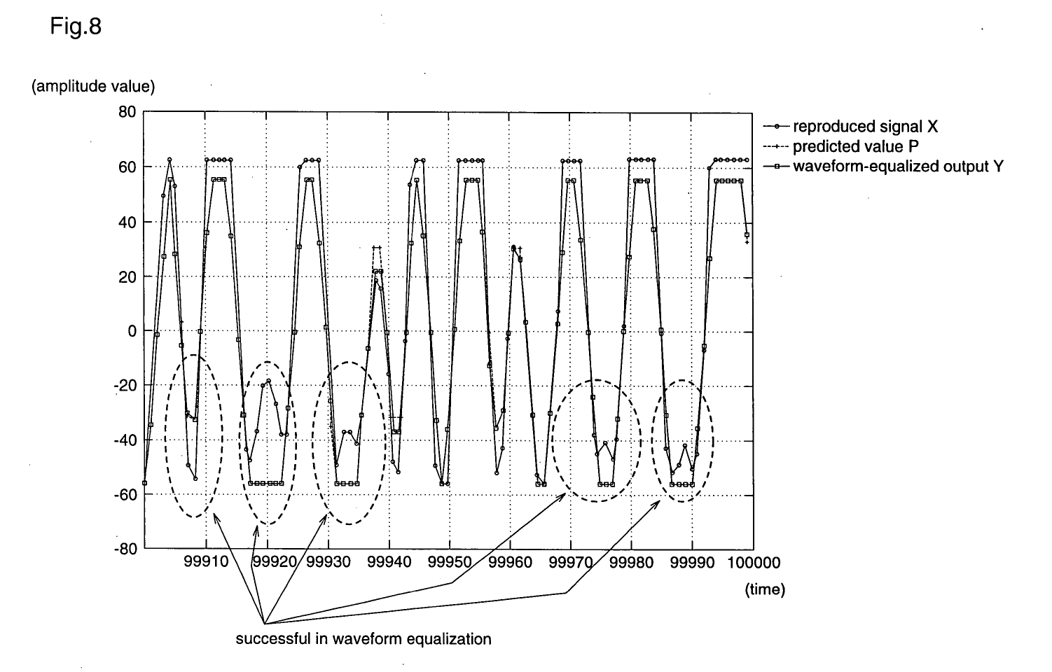

This is done by utilizing the fact that whether the waveform of the reproduced signal is normal (waveform Xa) or the waveform includes non-linear distortion (waveform Xb), the predicted value P is the same, as previously described with reference to FIG. 5. Thus, when the predicted value P generated from the reproduced signal X is output as a waveform-equalized output Y instead of the digital filter output X′ in a portion in which the waveform of the reproduced signal X may include non-linear distortion, waveform equalization can be performed without failure in waveform equalization even in a portion in which the prior art apparatus 400 might have failed to perform waveform equalization as in an area circled by dotted lines shown in FIG. 8.

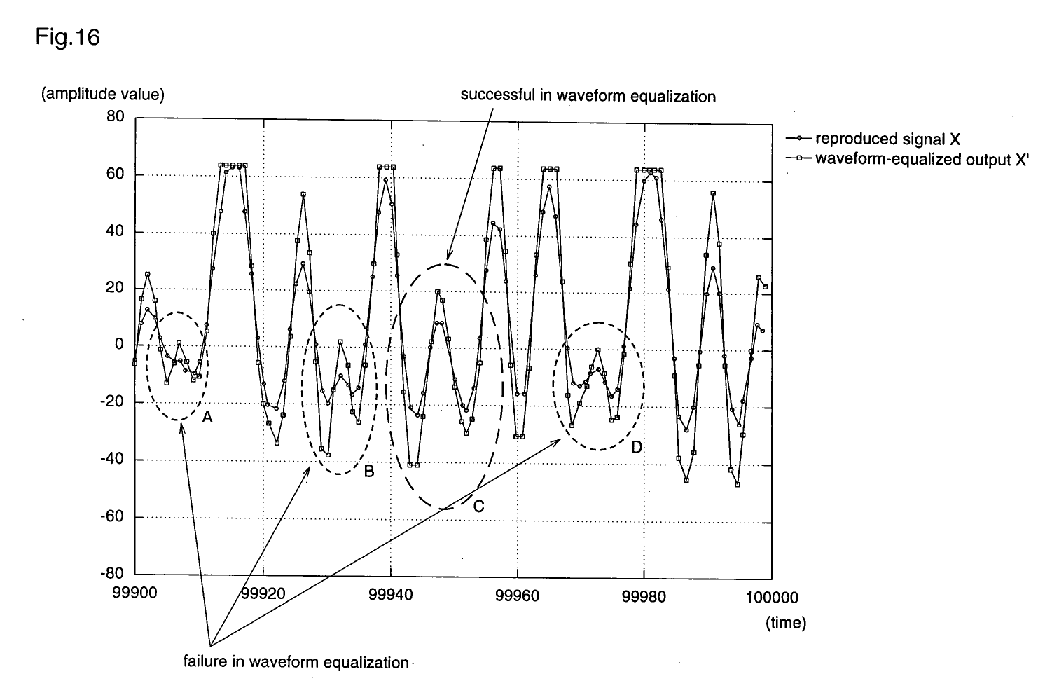

As described above, according to the first embodiment, the pattern predictor 103 creates a predicted value P of a reproduced signal X as well as judges whether the predicted value P is a previously set specific pattern or not. The reproduced signal X is subjected to adaptive equalization in the adaptive equalizer 110, and thereafter the selection circuit 104 selects one of the output from the adaptive equalizer 110 and the predicted value P of the reproduced signal from the pattern predictor 103 according to the judgement result, thereby to output the selected one as a waveform-equalized output Y. Therefore, even when the reproduced signal X which is input to the reproduced signal processing apparatus of the first embodiment has a waveform having non-linear distortion, on which a frequency component of the same band as that of the normal waveform is superimposed as described with reference to FIG. 16, the failure in waveform equalization caused by the non-linear distortion is eliminated, thereby suppressing the influence of the waveform distortion on the waveform-equalized output Y. As a result, in the reproduced signal processing apparatus 100 of the first embodiment, the preferable equalization characteristic can be obtained and the reproduced signal X can be always subjected to optimal adaptive equalization.

Then, while in the first embodiment a case where the number of coefficients Wₙ for determining an equalization characteristic of the digital filter 101 is five is taken as an example, the number of coefficients W is not restricted thereto.

### Embodiment 2

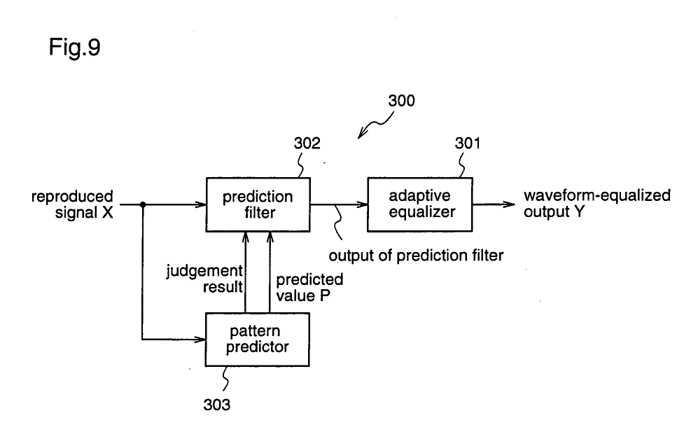

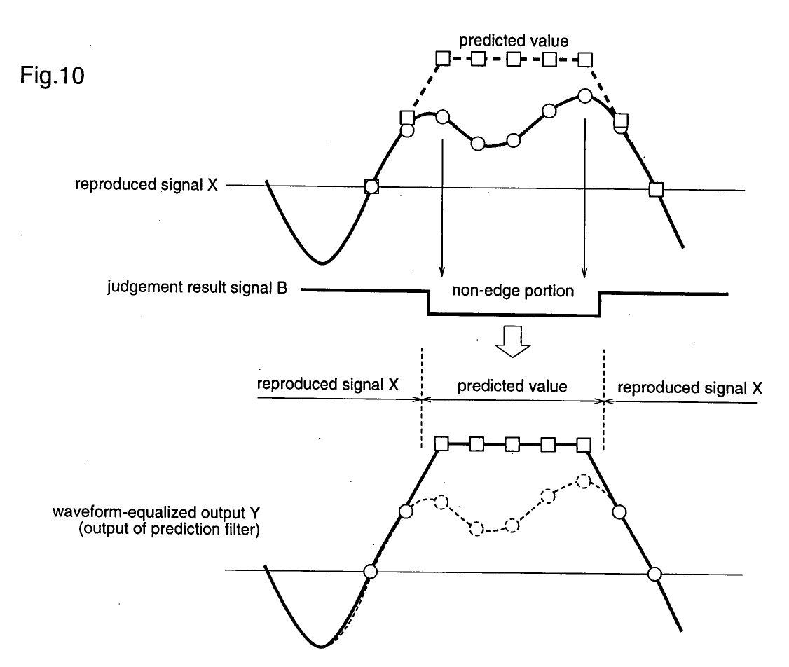

Hereinafter, a reproduced signal processing apparatus according to a second embodiment will be described with reference to FIGS. 9 and 10.

While in the above-described first embodiment a reproduced signal X is adaptively equalized by an adaptive equalizer initially, and thereafter a selection circuit in the post stage selects one of an output of the adaptive equalizer (digital filter output X′) and a predicted value P of the reproduced signal X which is predicted by a pattern predictor, thereby outputting a waveform-equalized output Y in which a non-linear distortion has been eliminated, a non-linear distortion of the reproduced signal X is eliminated through a filter, and thereafter an adaptive equalizer in the post stage adaptively equalizes the signal in which the non-linear distortion has been eliminated, in this second embodiment.

Initially, a construction of the reproduced signal processing apparatus according to the second embodiment will be described using FIG. 9.

In FIG. 9, a reproduced signal processing apparatus 300 according to the second embodiment comprises an adaptive equalizer 301, a prediction filter 302, and a pattern predictor 303. The adaptive equalizer 301 adaptively changes the equalization characteristic thereof according to the output from the prediction filter 302 described later, and performs waveform equalization on the output from the prediction filter 302, and the adaptive equalizer 301 mainly comprises a digital filter and a coefficient updater which updates coefficients Wₙ (n is an integer) for determining an equalization characteristic of the digital filter. As an example of a specific construction of the adaptive equalizer, an adaptive equalizer comprising a conventional digital filter 401 and coefficient updater 402 or an adaptive equalizer comprising a digital filter 101 and coefficient updater 102 which are described in the first embodiment may be taken.

Then, the pattern predictor 303 predicts a binary data sequence (a predicted value P) obtained from the reproduced signal X, and judges whether or not the predicted value P matches a previously set specific pattern to output the judgement result. The construction and operation of the pattern predictor 303 are the same as those of the pattern predictor 103 of the first embodiment.

Then, the prediction filter 302 subjects the reproduced signal X to filtering and the contents of the filtering to be executed is determined by the pattern predictor 303, and here one of the reproduced signal X and the predicted value P of the reproduced signal X which is predicted by the pattern predictor 303 is output according to the judgement result outputted from the pattern predictor 303. As a construction of the prediction filter 302, for example, a selection circuit for selecting the output value according to the judgement result is assumed.

Next, a series of operations of the reproduced signal processing apparatus 300 of the above-described construction according to the second embodiment will be described using FIG. 10. FIG. 10 is a waveform diagram for explaining the filtering performed by the prediction filter in the reproduced signal processing apparatus according to the second embodiment.

Initially, a reproduced signal X which is digitized by the quantization means not shown is input to the prediction filter 302 and the pattern predictor 303.

The predicted value P and the judgement result are created from the reproduced signal X which is input to the pattern predictor 303 as described in the first embodiment, and outputted to the prediction filter 302. Here, a portion in which the predicted value P is other than a maximum value and a minimum value is set as a previously set specific pattern, and a signal B shown in FIG. 6 is output as the judgement result from the judgement unit 236 in the pattern predictor 303.

Then, the prediction filter 302 outputs one of the reproduced signal X and the predicted value P as a prediction filter output on the basis of the judgement result.

Hereinafter, a specific description will be given using FIG. 10. Initially, when the reproduced signal X shown in FIG. 10 is input to the reproduced signal processing apparatus 300 of this embodiment, the pattern predictor 303 creates a predicted value P and judges whether the predicted value P matches the previously set specific pattern or not, and the prediction filter 302 outputs the reproduced signal X as it is as a prediction filter output in a portion where the predicted value P of the reproduced signal changes to “−25”, “0”, “25”, and the prediction filter 302 outputs the corresponding predicted value P, instead of the reproduced signal X, as a prediction filter output except in the portion where the predicted value P of the reproduced signal changes to “−25”, “0”, “25”, on the basis of the judgement result.

Thus, the prediction filter 302 eliminates non-linear distortion of the waveform of the input reproduced signal X and can supply a signal having no non-linear distortion (a prediction filter output) to the adaptive equalizer 301 in the post stage.

Then, the adaptive equalizer 301 adaptively equalizes the prediction filter output in which the non-linear distortion has been eliminated, thereby obtaining waveform-equalized output Y.

Then, while in the above description, as the filtering processing performed by the prediction filter 302, the prediction filter 302 outputs the reproduced signal X as it is as a prediction filter output in a portion where the predicted value P of the reproduced signal changes to “−25”, “0”, “25”, and outputs the corresponding predicted value P, instead of the reproduced signal X, as a prediction filter output except in the portion where the predicted value P of the reproduced signal changes to “−25”, “0”, “25”, on the basis of the judgement result from the pattern predictor 303, the component of the specific frequency band of the reproduced signal X is cut except in the portion where the predicted value P of the reproduced signal changes to “−25”, “0”, “25”, thereby outputting the resultant signal, as an example of another filtering method performed by the prediction filter 302.

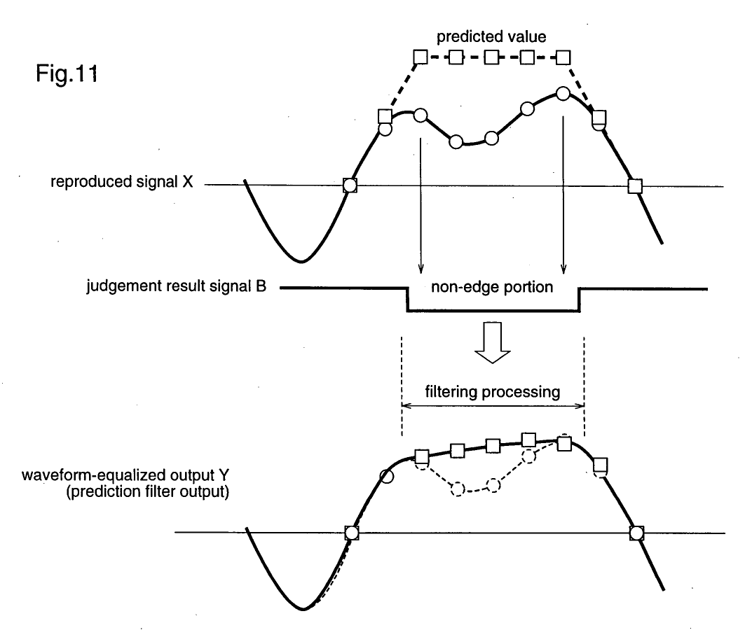

Hereinafter, a detailed description will be given using FIGS. 9 and 11. FIG. 11 is a diagram for explaining filtering performed by the prediction filter in the reproduced signal processing apparatus according to the modification of this second embodiment.

The reproduced signal processing apparatus 300 according to the modification of the second embodiment comprises a prediction filter 302, an adaptive equalizer 301, and a pattern predictor 303 like the above-described construction of the second embodiment shown in FIG. 9. The prediction filter 302 according to the modification of the second embodiment cuts the component of the specific frequency band of the input reproduced signal X according to the judgement result and outputs the resultant signal, and the prediction filter 302 is constructed as, for example, a digital filter as shown in FIG. 14. Then, the coefficient Wₙ of the digital filter which is the prediction filter 302 may be fixed or adaptively updated as in the first embodiment, and any coefficient may be used as long as the coefficient has a characteristic for eliminating the influence of the non-linear distortion of the waveform of the input reproduced signal X. Further, while in the second embodiment, the judgement result and the predicted value P are output from the pattern predictor 303 to the prediction filter 302, only the judgement result may be output in the modification of the second embodiment. The other construction is similar to that of the reproduced signal processing apparatus according to the second embodiment described above, and a description is omitted here.

Next, an operation of the reproduced signal processing apparatus 300 according to the modification of the second embodiment having the above-described construction will be described using FIG. 11. Initially, when the reproduced signal X as shown in FIG. 11 is input to the reproduced signal processing apparatus 300, the pattern predictor 303 predicts the predicted value P of the reproduced signal X and outputs the judgement result on the basis of the predicted value P. Then, the prediction filter 302 receives only the judgement result from the pattern predictor 303, and performs filtering for the reproduced signal X on the basis of the judgement result. Here, a judgement result signal B shown in FIG. 6 is taken as an example.

The prediction filter 302 outputs the input reproduced signal X as it is as a prediction filter output in a portion where the predicted value P of the reproduced signal changes to “−25”, “0”, “25”, while the prediction filter 302 cuts the component of the specific frequency band of the reproduced signal X and outputs the resultant signal as a prediction filter output instead of outputting the reproduced signal X except in the portion where the predicted value P of the reproduced signal changes to “−25”, “0”, “25”.

Thus, the prediction filter 302 according to the modification of the second embodiment performs filtering processing for cutting the component of the specific frequency band of the reproduced signal X in a portion where the predicted value P of the reproduced signal changes to “−25”, “0”, “25”, and even when the component of the same band as that of the signal whose frequency is to be cut is included in a portion where the predicted value P of the reproduced signal changes to “−25”, “0”, “25”, the prediction filter 302 does not cut the component.

Thus, the prediction filter 302 securely eliminates the non-linear distortion of the waveform of the input reproduced signal X and can supply waveform having little non-linear distortion to the adaptive equalizer 301 in the post stage.

Then, the output of the prediction filter in which the non-linear distortion has been eliminated as described above, is adaptively equalized by the adaptive equalizer 301, thereby obtaining a waveform-equalized output Y.

As described above, in the second embodiment, the prediction filter 302 subjects the reproduced signal X to filtering, and thereafter the adaptive equalizer 301 adaptively equalizes the reproduced signal which was subjected to the filtering. Therefore, even when the reproduced signal X input to the reproduced signal processing apparatus 300 of this embodiment has a waveform of non-linear distortion on which a frequency component of the same band as that of the normal waveform is superimposed as described with reference to FIG. 16, the failure in waveform equalization due to the non-linear distortion is eliminated, and thereby the influence of waveform distortion on the waveform-equalized output Y can be suppressed. As a result, in the reproduced signal processing apparatus 300 according to the second embodiment, a preferable equalization characteristic can be obtained and the reproduced signal X can be always subjected to optimal adaptive equalization.

### APPLICABILITY IN INDUSTRY

The reproduced signal processing apparatus and reproduced signal processing method of the present invention are extremely useful because they realize optimal equalization for coping with non-linear distortion which is partly caused due to production variances in medium such as an optical disk and a magnetic disk, or the like.

1. A reproduced signal processing apparatus for equalizing a waveform of a reproduced signal which is reproduced from a recording medium, comprising:
a digital filter for equalizing the reproduced signal;
a coefficient updater for adaptively updating coefficients for determining an equalization characteristic of the digital filter;
a pattern predictor for predicting a data sequence of the reproduced signal and outputting a predicted value of the reproduced signal, and judging whether or not the data sequence of the reproduced signal is a previously set specific pattern, thereby to output the judgement result; and
a selection circuit for selecting one of the output of the digital filter and the predicted value of the reproduced signal as a waveform-equalized output, and outputting the selected one.

2. The reproduced signal processing apparatus as defined in claim 1, wherein
the selection circuit selects the output of the digital filter when the judgement result indicates that the data sequence of the reproduced signal is the specific pattern, and
selects the predicted value when the judgement result indicates that the data sequence of the reproduced signal is not the specific pattern.

3. The reproduced signal processing apparatus as defined in claim 1, wherein
the coefficient updater updates the coefficients of the digital filter when the judgement result indicates that the data sequence of the reproduced signal is the specific pattern, and
does not update the coefficients of the digital filter when the judgement result indicates that the data sequence of the reproduced signal is not the specific pattern.

4. The reproduced signal processing apparatus as defined in claim 1, wherein
the coefficient updater adaptively updates the coefficients of the digital filter using the predicted value.

5. The reproduced signal processing apparatus as defined in claim 1, wherein
the digital filter equalizes the reproduced signal into multiple values and outputs the equalized signal, and
the specific patterns which are previously set in the pattern predictor are portions in which the data sequence of the reproduced signal changes from a minimum value up to a maximum value and in which it changes from the maximum value up to the minimum value.

6. The reproduced signal processing apparatus as defined in claim 1, wherein
the digital filter equalizes the reproduced signal into multiple values and outputs the equalized signal, and
the specific pattern which is previously set in the pattern predictor is a portion in which the data sequence of the reproduced signal is other than the minimum value and the maximum value.

7. The reproduced signal processing apparatus as defined in claim 5, wherein
the pattern predictor predicts the data sequence of the reproduced signal using partial response equalization, and judges whether the predicted data sequence of the reproduced signal matches the specific pattern or not.

8. A reproduced signal processing apparatus for equalizing a waveform of a reproduced signal which is reproduced from a recording medium, comprising:
a pattern predictor for judging whether or not the data sequence of the reproduced signal is a previously set specific pattern, thereby to output the judgement result;
a prediction filter for partially performing filtering on the reproduced signal on the basis of the judgement result; and
an adaptive equalizer for adaptively equalizing the output of the prediction filter.

9. The reproduced signal processing apparatus as defined in claim 8, wherein
the pattern predictor outputs a judgement result as to the data sequence of the reproduced signal and predicts the data sequence of the reproduced signal to output the predicted value of the reproduced signal;
the prediction filter outputs the reproduced signal when the judgement result indicates that the data sequence of the reproduced signal is the specific pattern; and
outputs the predicted value of the reproduced signal when the judgement result indicates that the data sequence of the reproduced signal is not the specific pattern.

10. The reproduced signal processing apparatus as defined in claim 8, wherein
the filtering processing performed by the prediction filter is to eliminate a specific frequency band from the waveform of the reproduced signal only when the judgement result indicates that the data sequence of the reproduced signal is not the specific pattern.

11. The reproduced signal processing apparatus as defined in claim 8, wherein
the specific patterns which are previously set in the pattern predictor are portions in which the data sequence of the reproduced signal which is predicted by the pattern predictor changes from a minimum value up to a maximum value and in which it changes from the maximum value up to the minimum value.

12. The reproduced signal processing apparatus as defined in claim 8, wherein
the specific pattern which is previously set in the pattern predictor is a portion in which the data sequence of the reproduced signal which is predicted by the pattern predictor is other than the minimum value and the maximum value.

13. A reproduced signal processing method for equalizing a waveform of a reproduced signal which is reproduced from a recording medium, comprising:
an adaptive equalization step of adaptively equalizing the reproduced signal with updating coefficients for determining an equalization characteristic of the waveform, thereby to output the equalized signal;
a prediction step of predicting the data sequence of the reproduced signal and outputting the predicted value of the reproduced signal;
a judgement step of judging whether or not the data sequence of the reproduced signal is a previously set specific pattern, thereby to output the judgement result; and
a selection step of selecting one of the output of the equalization step and the output of the prediction step as a waveform-equalized output, and outputting the selected one.

14. A reproduced signal processing method for equalizing a waveform of a reproduced signal which is reproduced from a recording medium, comprising:
a judgement step of judging whether or not the data sequence of the reproduced signal is a previously set specific pattern, thereby to output the judgement result;
a filtering step of partially performing filtering on the reproduced signal on the basis of the judgement result; and
an adaptive equalization step of adaptively equalizing the output of the filtering step.

15. The reproduced signal processing apparatus as defined in claim 6, wherein
the pattern predictor predicts the data sequence of the reproduced signal using partial response equalization, and judges whether the predicted data sequence of the reproduced signal matches the specific pattern or not.
